(19) United States
(12) Patent Application Publication
(10) Pub. No.: US 2006/0020540 A1
(43) Pub. Date: Jan. 26, 2006

(54) Method and apparatus for performing electronic transactions

(76) Inventor: Warrick James Cramer, Beaumaris (AU)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 10/505,641

(22) PCT Filed: Feb. 20, 2003
(86) PCT No.: PCT/AU03/00216

§ 371 Date: Aug. 19, 2004

(30) Foreign Application Priority Data
Feb. 20, 2002 (AU) PS 0661

(51) Int. Cl. G06Q 40/00

(52) U.S. Cl. 705/39

(57) ABSTRACT

The invention discloses a method for performing electronic transactions over a communications network. The communications network includes a user operable terminal (12), a remote electronic transaction processing system (16) and a product and/or service delivery means (14). The method includes the steps of requesting a desired product and/or service on the user operable terminal and validating the request at the remote electronic transaction processing system (16). The remote electronic transaction processing system (16) provides a first authorisation to the user operable terminal (12) from the remote electronic transaction processing system (16) and a second authorisation to the product and/or service delivery means (14). The desired product and/or service is then provided to the user from the product and/or service delivery means (14) when the user validates the first authorisation with the product and/or service delivery means (14).

The present invention relates to a method and system for performing electronic transactions over a communications network, and relates particularly, though not exclusively, to an alternative method and system for payment of goods and/or services via the use of a mobile communication device.

Prior to the present invention mobile phones and/or other wireless or non-wireless communication devices have been used in a variety of different procedures involving the transfer of funds between different accounts. Many systems which utilise communication devices to conduct electronic transactions are extremely complicated to use and sometimes involve large number of steps which can often deter users, or lead to errors. Many systems involve a third party, which is often a Service Provider, whom acts as an electronic wallet for the purchase of goods and/or services on behalf of their users.

Electronic monetary systems, or electronic wallet payment systems, are well known. U.S. Pat. No. 6,029,151, by Telefonaktiebolaget L M Ericsson (hereinafter the ‘ERICSSON’ patent) discloses a method and system for performing electronic money transactions. This system relies on Internet Service Providers (ISP's) taking responsibility for their signed up users payments for goods and/or services, by adding corresponding charges onto respective users bills/accounts. As such, an ISP functions as a third party intervening between a user and a merchant, and uses electronic money on behalf of a user to pay for goods and/or services requested by that particular user.

U.S. Pat. No. 5,991,749, by Paul H. Morrill, Jr. (hereinafter the ‘MORRILL’ patent) discloses a wireless telephony for collecting tolls, conducting financial transactions, and authorising other activities. In general, this system expands the function of a Service Provider's (SP's) central processing computer to include account and authorisation information such that a SP can act as an electronic wallet for purchases on behalf of their clients. In this system a user needs to enter specific codes on their mobile phone to conduct a transaction and is required to answer prompts whilst in the process of that transaction in order to complete the process. This process is similar to the BPay phone banking where payments can be made for products from the client's electronic wallet over the phone by entering account details, product/service information and authorisation codes by phone. U.S. Pat. No. 5,963,625, by AT&T Corp (hereinafter the ‘AT&T’ patent) discloses a method for providing called service provider control of caller access to pay services. This system provides for the establishment of service provider criteria controlling whether a particular call to a pay service provider is blocked or passed through a toll network to the pay service provider. Essentially this requires a caller scoring system which is/can be used to determine whether a caller is allowed/able to pay for particular goods and/or services. It is very similar to establishing a sound credit rating.

U.S. Pat. No. 5,023,904, by Science Dynamics Corporation (hereinafter the ‘SCIENCE’ patent) discloses a direct telephone dial ordering service wherein a calling customer can order goods and/or services from a given vendor without voice interchange. This subscriber based system allows a user to call into a vendors/merchants system and subsequently enter appropriate keystrokes to obtain goods/services.

Both ERICSSON and MORRILL disclose payment systems which require a third party, preferably a SP or ISP, to make payments to merchants on behalf of users. In both cases accounts for payment to third parties can be made via users existing accounts for service with these third parties. Although both systems are effective in enabling payment for goods and/or services via an electronic means, ERICSSON relies on various interfaces for verification of payments and requires the third partys computer system to have an electronic wallet facility. This subsequently requires ISP's or SP's to have agreements with various merchants for payments with electronic money. MORRILL on the other hand requires users to type multiple codes into their phones, which can include account details and costs of goods, amounting to a large number of entered digits, open for mistakes and errors in transactions. MORRILL also requires users' bank account details to be linked to the third party, which can also lead to security and privacy issues. In general, MORRILL is very similar to the phone banking system commonly known as ‘BPay’. The MORRILL patent offers little security regarding authentication to the client transacting and it does not capture data for the purpose of inventory management.

AT&T and SCIENCE are both subscriber based systems which means users must be registered before they are able to access electronic transaction services to purchase goods/services. With AT&T goods cannot be obtained instantly and SP criteria must be met before a user can purchase a product and/or service. This requires SP's have spare database capacity and caller scoring systems which act as credit rating. SCIENCE provides that its system can only be accessed via a phone line and that credit verification is required prior to purchasing, requiring extensive data processing. In general, SCIENCE is very similar to, if not the same as, many other automated bill payment systems utilising a phone network.

It is therefore an object of the present invention to provide an alternative and simplified method and system for payment of goods and/or services via electronic means over a communications network.

In one aspect of the invention there is provided a method for performing electronic transactions over a communications network, said communications network including at least one user operable terminal, a remote electronic transaction processing system and a product and/or service delivery means, said method including the steps of requesting a desired product and/or service on said at least one user operable terminal, validating said request at said remote electronic transaction processing system, said remote electronic transaction processing system providing a first authorisation to said at least one user operable terminal from said remote electronic transaction processing system, said remote electronic transaction processing system providing a second authorisation to said product and/or service delivery means from said remote electronic transaction processing system and providing said desired product and/or service to said user from said product and/or service delivery means when said user validates said first authorisation with said product and/or service delivery means by verification with said second authorisation.

Preferably said at least one user operable terminal is a communications device especially a telephone, mobile telephone, pager, personal computer, handheld computer and similar devices. In a practical embodiment said first and second authorisations are SMS messages and said at least one user operable terminal is a mobile phone. The product and/or service delivery means includes circuitry to accept its SMS message and process data in the message to enable validation by said user.

In a further aspect of the present invention there is provided a method for performing electronic transactions over a communications network having a remote electronic transaction processing system or central processing computer, at least one user operable terminal and dispensing terminal respectively, said method including the steps of: initiating a transaction by sending a request from said at least one user operable terminal to said central processing computer, via said communications network; receiving and validating said request at said central processing computer; acknowledging said request at said central processing computer by sending at least two acknowledgment receipts via said communications network wherein, at least one acknowledgment receipt is sent to said at least one user operable terminal and at least one acknowledgment receipt is sent to said at least one dispensing terminal; entering or sending said at least one user operable terminal acknowledgment receipt data into said at least one dispensing terminal; comparing said entered or sent said at least one user operable terminal acknowledgment receipt data with acknowledgment receipt data received by said at least one dispensing terminal; and dispensing goods and/or services and completing transaction upon verification of said acknowledgment receipt data at said at least one dispensing terminal.

Preferably said at least one user operable terminal is a is a pager, telephone or other personal handheld communications device. In a practical embodiment said user operable terminal is a wireless device. It is also preferred that said at least one dispensing terminal is a toll machine, ticket machine, vending machine, parking machine, or any other similar device which traditionally requires some form of money or cash-card to access its goods/services. Preferably sending of said acknowledgment receipts is achieved via an SMS service and said data transmitted with said acknowledgment receipts are digital codes of any predetermined length which are subsequently compared for the purpose of verification and completion of said transaction.

In a practical embodiment the present invention provides an alternative method for payment of goods and/or services provided by vending machines, using a mobile phone. Here a consumer dials a phone number displayed on the vending machine with their mobile phone and then follows any required prompts. Their mobile phone number and any other predetermined information is subsequently sent back to said central computer. The central computer then validates the request by sending, preferably via a Short Message Service (SMS), a unique code to the consumers phone and to the vending machine. The consumer then enters the code received on their mobile phone into the vending machine, which preferably has a numeric keypad with an LCD display. The vending machine then verifies the consumer entered code with that of its corresponding received code and upon verification the consumer can access the goods/services. Payment for the goods/services is then made through the cost of the call. One example of this system may be as follows: A can of drink may cost $1.40 through a vending machine using coins. If the consumer does not have the necessary money, he or she may dial a toll free number and go through the procedure outlined above. The goods/services could then be paid for by the addition of the cost of a mobile call to the initial $1.40 outlay, as an additional charge on the consumers mobile phone statement.

In yet a further practical embodiment the present invention provides an alternate means for purchasing goods and/or services over the Internet. In this embodiment, similar to the aforementioned embodiment, a consumer would dial a number on his mobile phone, and enter any required code/information, corresponding to goods/services on a merchants web page. Like before, a central computer would then send acknowledgments and the consumer could then proceed to the purchasing section of that web page and subsequently enter any data received via that acknowledgment. From here the merchant computer would then verify the transaction and dispense those goods and/or services required if verification was complete. Appropriate charges could then be added to the consumers mobile phone account.

In order that the invention may be more readily understood and put into practical effect, reference will now be made to the accompanying drawings, in which:—

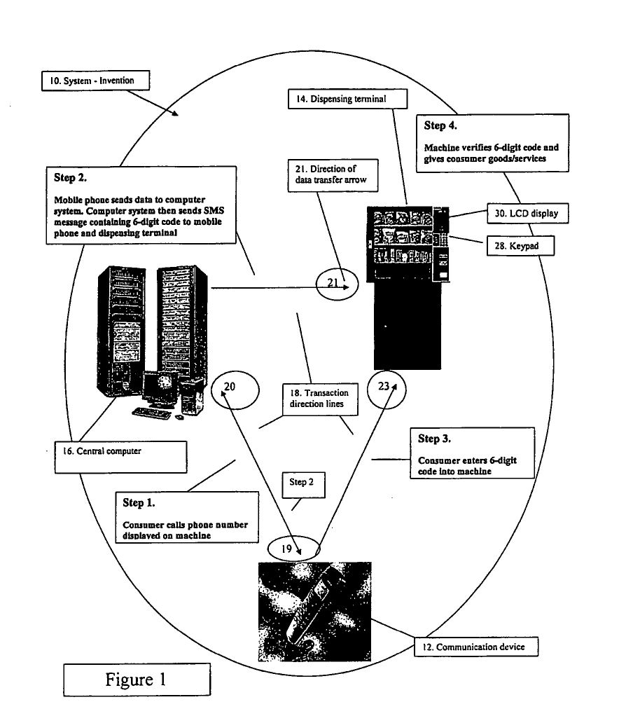

FIG. 1 is a block diagram of an electronic transaction system, made in accordance with a first preferred embodiment of the present invention;

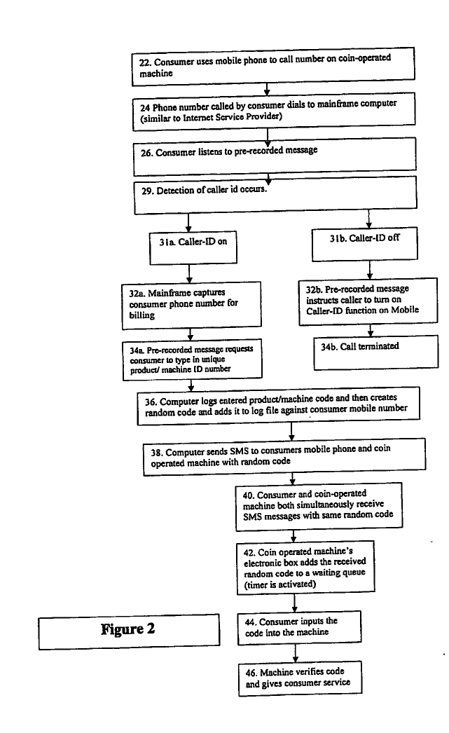

FIG. 2 is a flow diagram illustrating one method of realising the electronic transaction system of FIG. 1;

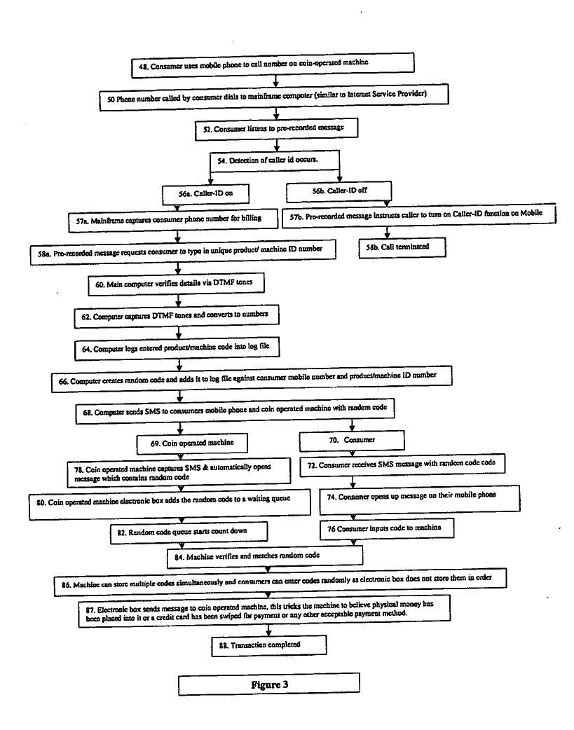

FIG. 3 is a flow diagram similar to the flow diagram of FIG. 2, illustrating in more detail the transmission of data that occurs; and

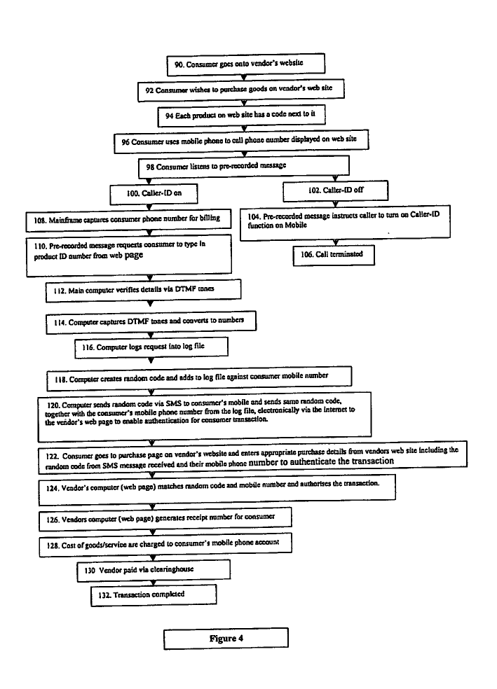

FIG. 4 is a flow diagram illustrating a method of realising a second preferred embodiment of the invention.

In FIG. 1, there is shown an electronic transaction system 10. Forming part of system 10 is a communication device 12, of any suitable type, for example a wireless mobile phone as shown. System 10 also includes a dispensing terminal 14, and a central computer 16 which acts as a remote electronic transaction processing system. Dispensing terminal 14 shown in FIG. 1 as a vending machine but, can be any suitable goods and/or service dispensing terminal, such as a ticket dispensing terminal, and as such the invention is not intended to be limited to the specific example shown. Central computer 16, which may be one or more computers, acts as a central hub for system 10, and as such controls and administers the ability to conduct transactions via system 10. Transmission direction lines 18, with arrow heads 19, 20, 21 and 23, illustrate the direction of travel of transmissions between communication device 12, dispensing terminal 14 and central computer 16, in system 10.

To better understand the operation of system 10, reference will now be made to Steps 1 to 4, in FIG. 1. At Step 1 it is assumed that a consumer (not shown) has decided to initiate a transaction via system 10. The consumer uses communication device 12 to call a number specified on dispensing terminal 14, which is directed to central computer 16, as indicated by transmission direction line 18 and arrow head 20 pointing toward central computer 16 from communication device 12. At Step 2, central computer 16 receives the initiation request from communication device 12, then sends an SMS message to both communication device 12 and dispensing terminal 14, as indicated by direction lines 18 and arrow heads 19,21. At this point it is assumed that if central computer 16 required any other information from the consumer, via communication device 12, that this information has been passed to central computer 16. Such a transmission of information could be achieved by central computer 16 capturing information entered into communication device 12 by the consumer, via DTMF tones. Contained within both SMS messages is data (not shown) of any predetermined length and type, for example a 6-digit code as used in this embodiment. At Step 3, the consumer receives the SMS message via communication device 12. The consumer can then read the SMS message, to reveal the contained 6-digit code, which is needed to be entered into dispensing terminal 14. Dispensing terminal 14 has a keypad 28 and LCD display 30, by which the consumer is able to enter the 6-digit code. However, entering of this code could be achieved in many different ways and the invention is not limited to the specific example given. Finally, at Step 4, dispensing terminal 14, after receiving the SMS message, verifies that the 6-digit code entered by the consumer corresponds or matches the 6-digit code contained within the SMS message sent to the consumer, and subsequently, upon verification, dispensing terminal vends/dispenses the goods and/or services (not shown) to the consumer.

It is important to note that in this example central computer 16 would use software to track all transactions and to communicate with communication device 12 and dispensing terminal 14 via a mobile phone network (not shown) using SMS. An electronic circuit (not shown) would be contained within dispensing terminal 14 which could cause dispensing terminal 14 to sense payment has occurred. The consumer will then have access to the goods or services obtained within.

The extra hardware (not shown) which may need to be contained within dispensing terminal 14 may consist of a mobile phone modem, which will communicate with central computer 16 via a mobile phone network. One LCD display 30 could be visible to the consumer and another LCD display (not shown) could be hidden internally for maintenance purposes. Dispensing terminal 14 may also need a circuit board, which could control and monitor the status of dispensing terminal 14, and run diagnostics every day. This circuit board, and any related software, could send an SMS message back to central computer 16 for maintenance, and could place an out of order message for the consumer on LCD display 30.

To make system 10 more secure and fool proof, the SMS message, sent to dispensing terminal 14, may be given a limited lifetime. In this manner the consumer would only have a set amount of time to enter the 6-digit code in order to claim their goods and/or services. This ensures that if the time has expired no other person can attempt to claim the goods and/or services. This also eliminates the need for dispensing terminal 14 having to keep a large number of codes in memory.

As such if the consumer did not receive an SMS message within a set period, they would call a help desk which could give them a new 6-digit code over the telephone phone by checking with central computer 16. If the timer has expired, the help desk may send a new code to dispensing terminal 14 and give the consumer a corresponding code to input. It may also be helpful for the help desk to be able to view all transactions and see whether codes have expired or have been used by requesting a downloaded history file from dispensing terminal 14.

One method of realising system 10 is given in FIGS. 2 and 3, which outline the working-flow and data-flow of this method respectively. Referring first to FIG. 2, at 22, where the consumer uses communication device 12, in this case a mobile phone, to dial a number which is shown on dispensing terminal 14, in this case any coin-operated machine. At 24 the phone number dials into a central computer 16. At 26 the consumer listens to a pre-recorded message, which explains the service offering, At 29 the central computer 16 detects the status of the caller-ID function on the callers mobile phone 12 from the incoming call. At 31b if the caller-ID mode detected is switched off, preventing logging of the incoming mobile phone number, then at 32b, a pre-recorded message instructs that the consumer can only access the service by first activating caller-ID to the ‘on’ mode on their mobile phone 12. At 34b the call is then terminated. If however, at 31a, the caller-ID was detected as being on then at 32a the central computer 16 automatically captures the incoming mobile phone number and adds it to a log file. At 34a, a pre-recorded message then instructs the consumer to enter the unique product code, where multiple products/services exist in a machine, or unique machine code, for single item machines, into their mobile phone 12 and explains that they will receive an SMS message in a pre-set time. At 36, the central computer logs the product/machine code entered by the consumer and then generates a random code, which is added to the log file on the central computer 16. At this point 36 the log file will contain information on the incoming phone number, the unique product/machine code and the random code generated. At 38 the central computer 16 sends the random code via SMS messages to both the consumer's mobile phone 12 and the coin-operated machine 14. Next at 40 both the consumers mobile phone 12 and the coin-operated machine 14 receive the same random code from the central computer 16. Once received, at 42, coin-operated machine 14 starts a timer which gives the then received code a predetermined lifespan. The consumer then enters, at 44, the predetermined code contained within their SMS message, into coin-operated machine 14, via keypad 28. Lastly, at 46, coin-operated machine 14 verifies the transaction and only upon verification dispenses the requested goods and/or services. Billing for the transaction may be enabled via the customer's mobile phone account using transaction data from the central computer 16.

It should be noted in all examples provided that collection of the customer's phone number by the central computer 16 will be an automated process where number barring is not activated by the customer. The customer will either be told to remove number barring or to enter their mobile phone number should phone number barring be detected by the central computer 16.

It should also be noted that the log file captures data on unique consumers, unique products at unique locations with unique codes of authentication stored as well. Such data enables both security for the consumer and considerable data for an inventory management system, together with the capability to profile consumers by matching unique phone number identification with demographic data stored in telecommunication carrier databases, or any database that the user chooses to subscribe to that may accompany the service offering.

Further security, not mentioned here, is available if deemed appropriate in the system by providing each unique customer with a service access PIN number, which would be entered (with reference to FIG. 2, 34 where the pre-recorded voice would ask for the customers unique security PIN to be entered prior to asking for the product/machine code. This is an optional feature (not shown), which is deemed not necessary given that PIN security already exists on mobile phones. However, it provides another layer of security which may be of value should the present invention be used for large value product purchases.

Reference will now be made to FIG. 3, which outlines the data-flow of the method of FIG. 2. In this diagram many steps are similar to corresponding steps in FIG. 2. Beginning at 48, the consumer initiates a transaction by dialling a number with mobile phone 12, which reaches central computer 16, at 50. After listening to a pre-recorded message at 52, the central computer 16 detects the status of the phone number identification function on the mobile phone 12 via the incoming call at 54. At 56b if the caller-ID mode detected is switched off, preventing logging of the incoming mobile phone number, then at 57b a pre-recorded message instructs the consumer that access to the service requires activating caller-ID to the ‘on’ mode on their mobile phone 12. At 58b the call is then terminated. If however, at 56a the caller-ID was detected as being ‘on’, then at 57a, the central computer 16 automatically captures the incoming mobile phone number and adds it to a log file. At 58a, a pre-recorded message then instructs the consumer to enter the unique product code, where multiple products/services exist in a machine, or unique machine code, for single item machines, into their mobile phone 12 and explains that they will receive an SMS message in a pre-set time. At 60 the central computer 16 verifies details via the DTMF tones sent from the consumer's mobile phone 12. Then at 62, the central computer 16 converts the DTMF codes to numbers and at 64 the central computer 16 logs the codes in the log file together with the mobile phone number that was logged at 57a It is assumed here that if any other information is required, these steps could be repeated as required. Also, the central computer 16, generates a random code and logs it together with the data already stored at 64 and 57a Then at 66 the central computer 16 generates SMS messages containing the random code and sends it to both the consumer's mobile phone 12 and the coin-operated machine 14. At this point the data-flow breaks off into two paths, one for coin-operated machine 14 at 69, and one for mobile phone 12 at 70. Firstly, at 70, then 72, the consumer receives the SMS message on mobile phone 12. After opening and reading the SMS message the consumer then enters the predetermined code into coin-operated machine 14, at 74 and 76, respectively. Switching back to 69, then to 78, coin-operated machine 14 receives the SMS message and automatically, once opened and processed and added to a queue in memory, starts a clock giving the predetermined code a lifespan, at 80 and 82 respectively. The remaining steps, 84, 86, 87 and 88, outline the way in which coin-operated machine 14 verifies and subsequently vends the requested goods and/or services.

A second embodiment is shown in FIG. 4. This embodiment is concerned with the purchasing of goods and/or services over the Internet and functions not unlike the embodiment given above. In general it is assumed that a vendor's web site which sells products/services would have a phone number (for dialling the service) with codes corresponding to different products and/or services. The consumer could then dial the phone number on the screen using mobile phone 12 and input the code next to a respective advertised product/service. Central computer 16 would then receive the request, and send a random code to the consumer on their mobile phone 12 via an SMS message. The consumer then would need to go to the appropriate purchasing screen on that particular web site and enter their name, delivery address, mobile phone number, random code, etc. Central computer 16 could then match against that sent to mobile phone 12 and authorise the purchase. As before, the charge for the goods/services could then be added to the mobile phone account of that consumer.

Reference will now be made to the work-flow diagram of FIG. 4. Here, at 90 and 92, the consumer navigates his way to a vendors/merchants web site and chooses a product/service for purchase. At 94, 96 and 98, the consumer observes a code beside the chosen product/service and dials a specified number on mobile phone 12, listens to prompts and enters any required information. If at 102 the caller-ID function on consumers mobile phone 12 is detected as being off, then at 104 a pre-recorded message informs the client that this function needs to be activated as ‘on’ in order to access this service and then at 106 the call is terminated. However, given that the caller-ID function on the consumer's mobile phone 12 is detected as being on, at 100, central computer 16 at 108, 110, 112, 114, 116, 118 and 120, then receives the consumer request, and forms a log file containing the customers phone number, the product code and a randomly generated code, at 118, and subsequently sends the consumer an SMS message, at 120, containing a predetermined code. At 122, the consumer receives the SMS message, opens and reads the predetermined code and then navigates to the appropriate section of the web page and enters the required details. Upon receiving these details, at 124, central computer 16 then validates the consumer request and at 126 the vendors computer/webpage issues a receipt number for the consumer, goods and/or services are provided via the completion of the online transaction. At this stage, 128, the bill may be settled on the account of mobile phone 12 of the consumer. At 130, the clearing house completes payment to the vendor. Then finally the transaction is complete at 132, with the vendor responsible for delivery, electronically or physically depending on the goods/services purchased. Typical examples would be the ability to download software on-line, or have flowers delivered to a home.

In the above example step 94 can be substituted by clicking on the desired product and/or service to allow details of the consumers mobile phone to be entered on the webpage. This would avoid the consumer having to dial a telephone number. Also this would automate the product code being sent to the central computer 16. However, the SMS message at 120 sent by central computer 16, and subsequent steps are still essential to ensure consumer security via authentication that the consumer has the mobile phone 12 in hand and not merely a list of mobile phone numbers.

Although not specified in the aforementioned embodiments, it is to be assumed that system 10 may included features such as: software that could be able to communicate with machine hardware (ie: communication device 12 or dispensing terminal 14); and software that could track all transactions and that could download, at any specified time, a statement of all transactions from dispensing terminal 12, including the amount or frequency of usage for any dispensing terminal 12.

This invention may also be used as a market research tool. Wherein, the said invention could make it possible to map the demographics of a particular user by recording what products they purchased and in what geographic areas, eg how many product(s) were purchased in a particular area, who purchased them and what time the purchase took place.

Inventory management for the benefit of vendors is therefore enabled. Further, where access to demographic information on customers may be matched (eg from a mobile phone carriers database) to mobile phone numbers recorded by the system, further consumer behaviour by demographic analysis may be facilitated. Valuable marketing information is recorded by the present invention: the ability to capture all transaction data including product type purchased, time of transaction, specific geographic location of transaction, average time of transaction, and number of transactions by unique customers over any period selected. Software enabling such analysis (not shown here) would be written in addition to the present invention described in this document. The value of the data logged on the central computer 16 is considerable as is the unique security feature using SMS message verification of codes for customer authentication.

It is also assumed that system 10 may include means (not shown) for dealing with cases such as when a consumer makes a mistake, or wishes not to purchase the item for which they originally initiated a transaction. A consumer may be able to, even after entering all information and receiving an acknowledgment, contact a help desk, or the like, which could verify their request by downloading machine history and matching information against a database. If everything is verified, a consumer could receive a credit in whichever form a vendor decides.

The present invention may have a variety of uses commercially. For example, a consumer may want to wash their car at a public car wash, but discover that they have forgotten their wallet. They may also need to pay a toll or a parking fee at a parking meter, but not have the appropriate coins. In either of these examples, so long as the consumer had their mobile phone they would be able to make payment. Other commercial examples may include: paying for arcade games, trolleys at an airport, or even a movie ticket The invention may even be used as an alternative to EFTPOS machines for small purchases. Innumerable commercial applications exist.

The invention may make it possible for a telecommunications carrier to increase their revenues. Giving them the ability to act as a large credit organisation, like a bank, or a Visa/MasterCard system. Telecommunication carriers would also be able to block certain users from using this service by barring their mobile phone account to specific numbers, e.g. blocking a phone account from making overseas calls. This provides the ability to stop a user with bad credit from accessing this system.

It is clear that variations may be made. Dispensing terminal 14 may include a telephone handset to allow the consumer to avoid dialling the number from his phone other variations would be envisaged by the man skilled in the art.

The present invention therefore provides a smart and alternative, electronic transaction method and system which enables consumers to purchase goods and/or services via a communications device, such as a mobile phone, by adding the cost of the purchased goods and/or services directly to their preexisting accounts with carriers, as an additional charge. It is recommended (although not required) that the present invention utilise a national free-call number(s) for the service, to reduce the cost of the service to the customer. The advantage of choosing the option of using a single national free-call number is that customers can store the service number as a single keystroke number (for rapid dial) to access the service. The present invention offers a simple and convenient method for conducting transactions which also offers increased security as many mobile phones require PIN numbers to operate them, meaning only individual owners are able to operate them. The present invention offers unique customer security (authentication) in the form of the independent code matching via SMS and the data capture of transaction data via the central computer system provides significant marketing appeal for commercial application.

Although the preferred embodiments have been described with reference to SMS messages the invention is not limited to that form of messaging. Any form of electronic receipting is encompassed by the invention as it will be recognised that the invention would cover the use of SMS, as well as MMS (Multimedia Messaging Service), Internet, or any other communications technology that allows delivery of data to both the user operable terminal and the dispensing devise. The delivery mode chosen will depend on the technology used to employ the invention. For example technology such as 3G will enable the choice of Internet transfer of the acknowledgement receipts sent from the central processing computer to the user operable terminal and of the acknowledgment receipt sent to the dispensing terminal, replacing the need for SMS.

The invention will be understood to embrace many further modifications as will be readily apparent to persons skilled in the art and which will be deemed to reside within the broad scope and ambit of the invention, there having been set forth herein only the broad nature of the invention and certain specific embodiments by way of example.

Where the terms “comprise”, “comprises”, “comprised” or “comprising” are used in this specification, they are to be interpreted as specifying the presence of the stated features, integers, steps or components referred to, but not to preclude the presence or addition of one or more other feature, integer, step, component or group thereof.

1-12. (canceled)

13. A method for performing electronic transactions over a communications network, said communications network including at least one user operable terminal, a remote electronic transaction processing system and a product and/or service delivery means, said method including the steps of requesting a desired product and/or service on said at least one user operable terminal, validating said request at said remote electronic transaction processing system, said remote electronic transaction processing system providing a first authorisation to said at least one user operable terminal from said remote electronic transaction processing system, said remote electronic transaction processing system providing a second authorisation to said product and/or service delivery means from said remote electronic transaction processing system and providing said desired product and/or service to said user from said product and/or service delivery means when said user validates said first authorisation with said product and/or service delivery means.

14. The method of claim 13, wherein said at least one user operable terminal is a communications device especially a telephone, mobile telephone, pager, personal computer, handheld computer and similar devices.

15. The method of claim 13, wherein said first and second authorisations are electronic receipts and said at least one user operable terminal is a mobile phone.

16. The method of claim 14, wherein said first and second authorisations are electronic receipts and said at least one user operable terminal is a mobile phone.

17. The method of claim 15, wherein said first and second authorisations are SMS messages.

18. The method of claim 16, wherein said first and second authorisations are SMS messages.

19. The method of claim 17, wherein the product and/or service delivery means includes circuitry to accept its SMS message and process data in the message to enable validation by said user.

20. The method of claim 18, wherein the product and/or service delivery means includes circuitry to accept its SMS message and process data in the message to enable validation by said user.

21. The method of claim 13, further including use of two user operable terminals, a first user operable terminal being a mobile phone and a second user operable terminal being a computer connected to the Internet, whereby said request is sent from said mobile phone based on information displayed on said second user operable terminal, said first authorisation is received by said mobile phone, and said second authorisation is additionally processed by said second user operable terminal.

22. A method for performing electronic transactions over a communications network having a remote electronic transaction processing system or central processing computer, at least one user operable terminal and dispensing terminal respectively, said method including the steps of: initiating a transaction by sending a request from said at least one user operable terminal to said central processing computer, via said communications network; receiving and validating said request at said central processing computer; acknowledging said request at said central processing computer by sending at least two acknowledgment receipts via said communications network wherein, at least one acknowledgment receipt is sent to said at least one user operable terminal and at least one acknowledgment receipt is sent to said at least one dispensing terminal; entering or sending said at least one user operable terminal acknowledgment receipt data into said at least one dispensing terminal; comparing said entered or sent said at least one user operable terminal acknowledgment receipt data with acknowledgment receipt data received by said at least one dispensing terminal; and dispensing goods and/or services and completing transaction upon verification of said acknowledgment receipt data at said at least one dispensing terminal.

23. The method of claim 22, wherein said at least one user operable terminal is a is a pager, telephone or other personal handheld communications device.

24. The method of claim 22, wherein said user operable terminal is a wireless device.

25. The method of claim 23, wherein said user operable terminal is a wireless device.

26. The method of claim 22, wherein said at least one dispensing terminal is a toll machine, ticket machine, vending machine, parking machine, or any other similar device which traditionally requires some form of money or cash-card to access its goods/services.

27. The method of claim 23, wherein said at least one dispensing terminal is a toll machine, ticket machine, vending machine, parking machine, or any other similar device which traditionally requires some form of money or cash-card to access its goods/services.

28. The method of claim 24, wherein said at least one dispensing terminal is a toll machine, ticket machine, vending machine, parking machine, or any other similar device which traditionally requires some form of money or cash-card to access its goods/services.

29. The method of claim 25, wherein said at least one dispensing terminal is a toll machine, ticket machine, vending machine, parking machine, or any other similar device which traditionally requires some form of money or cash-card to access its goods/services.

30. The method of claim 22, wherein sending of said acknowledgment receipts is achieved via an SMS service and said data transmitted with said acknowledgment receipts are digital codes of any predetermined length which are subsequently compared for the purpose of verification and completion of said transaction.

31. The method of claim 23, wherein sending of said acknowledgment receipts is achieved via an SMS service and said data transmitted with said acknowledgment receipts are digital codes of any predetermined length which are subsequently compared for the purpose of verification and completion of said transaction.

32. The method of claim 24, wherein sending of said acknowledgment receipts is achieved via an SMS service and said data transmitted with said acknowledgment receipts are digital codes of any predetermined length which are subsequently compared for the purpose of verification and completion of said transaction.

33. The method of claim 25, wherein sending of said acknowledgment receipts is achieved via an SMS service and said data transmitted with said acknowledgment receipts are digital codes of any predetermined length which are subsequently compared for the purpose of verification and completion of said transaction.

34. The method of claim 26, wherein sending of said acknowledgment receipts is achieved via an SMS service and said data transmitted with said acknowledgment receipts are digital codes of any predetermined length which are subsequently compared for the purpose of verification and completion of said transaction.

35. The method of claim 27, wherein sending of said acknowledgment receipts is achieved via an SMS service and said data transmitted with said acknowledgment receipts are digital codes of any predetermined length which are subsequently compared for the purpose of verification and completion of said transaction.

36. The method of claim 28, wherein sending of said acknowledgment receipts is achieved via an SMS service and said data transmitted with said acknowledgment receipts are digital codes of any predetermined length which are subsequently compared for the purpose of verification and completion of said transaction.

37. The method of claim 29, wherein sending of said acknowledgment receipts is achieved via an SMS service and said data transmitted with said acknowledgment receipts are digital codes of any predetermined length which are subsequently compared for the purpose of verification and completion of said transaction.
